(19) United States
(12) Patent Application Publication
(10) Pub. No.: US 2025/0157466 A1
(43) Pub. Date: May 15, 2025

(54) VOICE COMMAND ACCEPTANCE APPARATUS AND VOICE COMMAND ACCEPTANCE METHOD

(71) Applicant: JVCKENWOOD Corporation, Yokohama-shi (JP)

(72) Inventor: Ryohei Sunaga, Yokohama-shi (JP)

(21) Appl. No.: 19/004,530

(22) Filed: Dec. 30, 2024

Related U.S. Application Data
(63) Continuation of application No. PCT/JP2023/021310, filed on Jun. 8, 2023.

(30) Foreign Application Priority Data
Aug. 3, 2022 (JP) 2022-123854
Feb. 6, 2023 (JP) 2023-015969

(51) Int. Cl. G10L 15/22; G10L 15/00

(52) U.S. Cl. CPC G10L 15/22; G10L 15/005; G10L 2015/223

(57) ABSTRACT

A voice command acceptance apparatus includes a voice command acceptance unit that accepts a voice command, t a detection unit that acquires information on a language that is used by a person who speaks a voice command, and t an execution control unit that, when the voice command acceptance unit accepts a voice command, executes a function with respect to the accepted voice command. When it is determined that the language that is used by the person is a language that is usable as the voice command, the voice command acceptance unit accepts a voice command if a recognition rate of the voice command that is acquired by the voice command acceptance unit is equal to or larger than a first threshold, and when it is determined that the language that is used by the person is not the language that is usable as the voice command, the voice command acceptance unit accepts a voice command if the recognition rate of the voice command that is acquired by the voice command acceptance unit is equal to or larger than a second threshold that is smaller than the first threshold.

### CROSS-REFERENCE TO RELATED APPLICATIONS

This application is a Continuation of PCT International Application No. PCT/JP2023/021310 filed on Jun. 8, 2023 which claims the benefit of priority from Japanese Patent Application No. 2022-123854 filed on Aug. 3, 2022 and Japanese Patent Application No. 2023-015969 filed on Feb. 6, 2023, the entire contents of all of which are incorporated herein by reference.

### BACKGROUND OF THE INVENTION

### 1. Field of the Invention

The present disclosure relates to a voice command acceptance apparatus and a voice command acceptance method.

### 2. Description of the Related Art

An apparatus that performs operation by a voice command is diversified. For example, as an in-vehicle recording apparatus, that is, what is called a drive recorder, an apparatus that performs shock detection by an acceleration sensor and performs event recording by a voice command is known (for example, see DRV-MR760 [searched on Dec. 20, 2021], the Internet (URL: https://www.kenwood.com/jp/car/drive-recorders/products/drv-mr760/)). The event recording by a voice command does not need operation on a touch panel or the like while driving, such as when an accident in which a subject vehicle is not involved is to be recorded, and therefore, it is possible to perform the event recording safely. Japanese Unexamined Patent Application Publication No. 2020-154904 discloses a drive recorder that performs event recording by giving an instruction by voice with respect to event detection based on acceleration.

A voice command for instructing the drive recorder to perform event recording is set in advance such that a voice command, such as “Ro-Ku-Ga-Ka-I-Shi”, is to be accepted, for example. The voice command needs to be consist of a certain number of syllables to prevent erroneous detection by different voice. For example, “Ro-Ku-Ga-Ka-I-Shi” is consist of six syllables. Therefore, to make the voice command be accurately recognized, a speaker usually speaks in a direction toward a microphone that receives spoken voice of the voice command, such as a direction toward the drive recorder. A general drive recorder is installed in a front part of the vehicle when viewed from a passenger who is the speaker, and therefore, input of the voice command in a state in which the speaker faces a traveling direction that is a forward direction of the vehicle is appropriately recognized.

However, when a voice command is spoken in a situation in which the voice command is not appropriately recognized, a recognition rate of the voice command is reduced, so that, in some cases, it becomes difficult to receive an instruction given by the voice command. In this case, for example, as for a voice command for instructing operation that needs to be performed urgently or immediately, such as a voice command for performing event recording by the drive recorder, operation may be delayed due to restatement of the voice command or the like. The situation in which the voice command is not appropriately recognized may occur in a state in which, for example, a person who speaks the voice command is not able to appropriately speak the voice command.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A voice command acceptance apparatus according to the present disclosure comprising: a voice command acceptance unit that accepts a voice command; a detection unit that acquires information on a language that is used by a person who speaks a voice command; and an execution control unit that, when the voice command acceptance unit accepts a voice command, executes a function with respect to the accepted voice command, wherein when it is determined that the language that is used by the person is a language that is usable as the voice command, the voice command acceptance unit accepts a voice command if a recognition rate of the voice command that is acquired by the voice command acceptance unit is equal to or larger than a first threshold, and when it is determined that the language that is used by the person is not the language that is usable as the voice command, the voice command acceptance unit accepts a voice command if the recognition rate of the voice command that is acquired by the voice command acceptance unit is equal to or larger than a second threshold that is smaller than the first threshold.

A voice command acceptance method implemented by a voice command acceptance apparatus, the voice command acceptance method according to the present disclosure comprising: acquiring information on a language that is used by a person who speaks a voice command; accepting, when it is determined that the language that is used by the person is a language that is usable as the voice command, a voice command if a recognition rate of the voice command is equal to or larger than a first threshold, accepting, when it is determined that the language that is used by the person is not the language that is usable as the voice command, a voice command if the recognition rate of the voice command is equal to or larger than a second threshold that is smaller than the first threshold; and executing, when the voice command is accepted, a function with respect to the accepted voice command.

### BRIEF DESCRIPTION OF THE DRAWINGS

FIG. 1 is a block diagram illustrating a configuration example of a recording apparatus according to a first embodiment;

FIG. 2 is a flowchart illustrating the flow of a process performed by a control unit according to the first embodiment;

FIG. 3 is a block diagram illustrating a configuration example of a voice command acceptance apparatus according to a second embodiment;

FIG. 4 is a flowchart illustrating the flow of a process performed by the voice command acceptance apparatus according to the second embodiment;

FIG. 5 is a block diagram illustrating a configuration example of a recording apparatus according to a third embodiment;

FIG. 6 is a flowchart illustrating the flow of a process performed by a control unit according to the third embodiment;

FIG. 7 is a block diagram illustrating a configuration example of a voice command acceptance apparatus according to a fourth embodiment; and

FIG. 8 is a flowchart illustrating the flow of a process performed by the voice command acceptance apparatus according to the fourth embodiment.

### DETAILED DESCRIPTION OF THE PREFERRED EMBODIMENTS

Embodiments according to the present disclosure will be described in detail below with reference to the accompanying drawings. The present disclosure is not limited by the embodiments below. Further, in the embodiments below, the same components are denoted by the same reference symbols, and repeated explanation will be omitted. Furthermore, a voice command acceptance apparatus according to the present disclosure may be various kinds of apparatuses that perform operation by using a voice command, and applicable apparatuses are not limited by the embodiments below.

### First Embodiment

In a first embodiment, a recording apparatus that is used in a vehicle will be described as an example of the voice command acceptance apparatus.

### Recording Apparatus

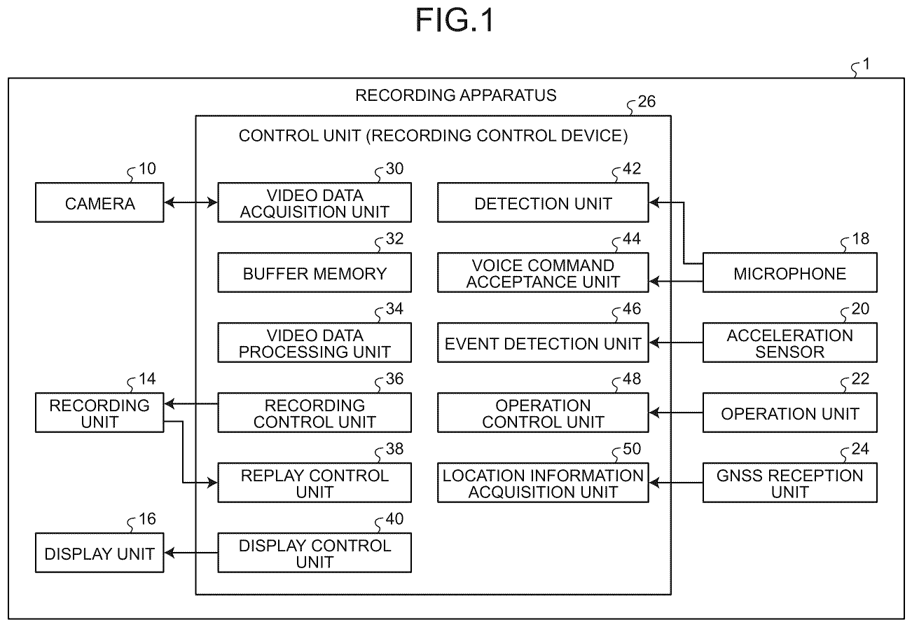

A configuration example of the recording apparatus according to the first embodiment will be described with reference to FIG. 1. FIG. 1 is a block diagram illustrating a configuration example of the recording apparatus according to the first embodiment.

A recording apparatus 1 is what is called a drive recorder that detects an event that has occurred with respect to a vehicle and records a video or the like in accordance with an instruction given by a user. The recording apparatus 1 may be an apparatus that is mounted on the vehicle or a portable apparatus that is available in the vehicle. The recording apparatus 1 has a video replay function, and therefore, may be referred to as a recording and replay apparatus. The recording apparatus 1 may be implemented so as to include a function or a configuration of a device that is installed in the vehicle in advance, a navigation device, or the like. The recording apparatus 1, by registration of a language, as a voice command, which is used by a passenger including a driver of the vehicle, performs a process of changing a recognition rate of a voice command to be accepted, in accordance with whether or not the language is usable as the voice command.

As illustrated in FIG. 1, the recording apparatus 1 includes a camera 10, a recording unit 14, a display unit 16, a microphone 18, an acceleration sensor 20, an operation unit 22, a Global Navigation Satellite System (GNSS) reception unit 24, and a control unit (recording control device) 26. The recording apparatus 1 may be an apparatus that includes the camera 10 and the microphone 18 in an integrated manner, or an apparatus in which the camera 10 and the microphone 18 are separated from each other.

The camera 10 is a camera that captures an image of surroundings of the vehicle. As one example, the camera 10 may be a camera that is unique to the recording apparatus 1 or may be a plurality of cameras that capture front-back directions or the like of the vehicle. In the first embodiment, for example, the camera 10 includes a plurality of cameras that are arranged facing forward and backward of the vehicle, and capture images of surroundings around the front and the back of the vehicle. The camera 10 may be, for example, a single camera that is able to capture a spherical image or a hemi-spherical image. The camera 10 outputs captured video data to a video data acquisition unit 30 of the control unit 26. The video data is a moving image that is formed of images at 30 frames per second, for example.

The recording unit 14 is used for temporarily storing data in the recording apparatus 1, for example. For example, the recording unit 14 is a semiconductor memory device, such as a Random Access Memory (RAN) or a Flash Memory, or a recording medium, such as a memory card. Alternatively, the recording unit 14 may be an external recording unit that is wirelessly connected via a communication apparatus (not illustrated). The recording unit 14 records therein loop recording video data or event data based on a control signal that is output from a recording control unit 36 of the control unit 26.

The display unit 16 is, for example, a display device that is unique to the recording apparatus 1, a display device that is shared with a different system including a navigation system, or the like. The display unit 16 may be formed in an integrated manner with the camera 10. The display unit 16 is a display that includes, for example, a Liquid Crystal Display (LCD), an Organic Electro-Luminescence (EL), or the like. In the first embodiment, the display unit 16 is arranged on a dashboard, an instrument panel, a center console, or the like in front of the driver of the vehicle. The display unit 16 displays a video based on a video signal that is output from the recording control unit 36 of the control unit 26. The display unit 16 displays a video that is being captured by the camera 10 or a video that is recorded in the recording unit 14.

The microphone 18 collects voice data of voice inside the vehicle. In the first embodiment, the microphone 18 is arranged at a position at which voice that is spoken by the passenger including the driver of the vehicle can be acquired. The microphone 18 is arranged on, for example, the dashboard, the instrument panel, the center console, or the like. The microphone 18 collects voice data related to spoken voice or conversations of a passenger inside the vehicle, and outputs the voice data to a detection unit 42. The microphone 18 collects voice related to a voice command for the recording apparatus 1. The microphone 18 outputs the voice related to the voice command to a voice command acceptance unit 44. The microphone 18 may output the collected voice to the video data acquisition unit 30, and the recording control unit 36 may record the loop recording video data or the event data that includes the voice.

The acceleration sensor 20 is a sensor that detects acceleration that occurs with respect to the vehicle. The acceleration sensor 20 outputs a detection result to an event detection unit 46 of the control unit 26. The acceleration sensor 20 is, for example, a sensor that detects acceleration in three-axis directions. The three-axis directions are a front-back direction, a left-right direction, and a vertical direction of the vehicle.

The operation unit 22 is able to receive various kinds of operation on the recording apparatus 1. For example, the operation unit 22 is able to receive operation of manually storing captured video data, as event data, in the recording unit 14. For example, the operation unit 22 is able to receive operation of replaying the loop recording video data or the event data that is recorded in the recording unit 14. For example, the operation unit 22 is able to receive operation of deleting the event data that is recorded in the recording unit 14. For example, the operation unit 22 is able to receive operation of terminating loop recording. The operation unit 22 outputs operation information to an operation control unit 48 of the control unit 26.

The GNSS reception unit 24 includes a GNSS receiver for receiving a GNSS signal from a GNSS satellite, or the like. The GNSS reception unit 24 outputs the received GNSS signal to a location information acquisition unit 50 of the control unit 26.

The control unit 26 is a recording control device that controls each of the units of the recording apparatus 1. The control unit 26 includes, for example, an information processing device, such as a Central Processing Unit (CPU) or a Micro Processing Unit (MPU), and a storage device, such as a Random Access Memory (RAN) or a Read Only Memory (ROM). The control unit 26 executes a program that controls operation of the recording apparatus 1 according to the present disclosure. The control unit 26 may be implemented by, for example, an integrated circuit, such as an Application Specific Integrated Circuit (ASIC) or a Field Programmable Gate Array (FPGA). The control unit 26 may be implemented by a combination of hardware and software.

The control unit 26 includes the video data acquisition unit 30, a buffer memory 32, a video data processing unit 34, the recording control unit 36, a replay control unit 38, a display control unit 40, the detection unit 42, the voice command acceptance unit 44, the event detection unit 46, the operation control unit 48, and the location information acquisition unit 50 as functional blocks that are implemented by a configuration of the control unit 26 or execution of a program.

The video data acquisition unit 30 acquires video data in which an image of surroundings of the vehicle is captured. Specifically, the video data acquisition unit 30 acquires the video data that is captured by the camera 10. The video data acquisition unit 30 outputs the acquired video data to the buffer memory 32. The video data that is acquired by the video data acquisition unit 30 is not limited to data that includes only a video, but may be video data that includes a video and voice. The video data acquisition unit 30 may acquire, as the video data, video data in which a spherical image or a hemi-spherical image is captured.

The buffer memory 32 is an internal memory that is included in the recording apparatus 1, and is a memory for temporarily recording video data of a certain period of time, which is acquired by the video data acquisition unit 30, while updating the video data.

The video data processing unit 34 converts the video data that is temporarily stored in the buffer memory 32 into an arbitrary file format, such as the MP4 format, in which the video data is encoded by codec of an arbitrary system, such as H.264 or Moving Picture Experts Group (MPEG-4), for example. The video data processing unit 34 generates video data as a file of a certain period of time from the video data that is temporarily stored in the buffer memory 32. As a specific example, the video data processing unit 34 generates, as a file, video data of 60 seconds in order of recording, from the video data that is temporarily stored in the buffer memory 32. The video data processing unit 34 outputs the generated video data to the recording control unit 36. The video data processing unit 34 outputs the generated video data to the display control unit 40. A period of the video data that is generated as a file is set to 60 seconds as one example, but embodiments are not limited to this example.

The recording control unit 36 performs control of recording, in the recording unit 14, the video data that is generated as a file by the video data processing unit 34. In a period in which a loop recording process is performed, such as when an accessory power supply of the vehicle is turned on, the recording control unit 36 records video data that is generated as a file by the video data processing unit 34, as overwritable video data, in the recording unit 14. The recording control unit 36 continuously records, in the recording unit 14, the video data that is generated by the video data processing unit 34 in the period in which the loop recording process is performed, and records the video data such that the oldest video data is overwritten with new video data when the capacity of the recording unit 14 becomes full.

When the voice command acceptance unit 44 receives an instruction on event detection by a voice command, the recording control unit 36 stores, as the event data, the first video data that includes a time point at which the instruction on the event detection is received. The recording control unit 36 stores the event data, as data for which overwrite is inhibited, in the recording unit 14. For example, the recording control unit 36 copies, from the buffer memory 32, video data of a predetermined period of about 10 seconds before and after the time point at which the voice command acceptance unit 44 receives event detection by the voice command, and stores the video data as the event data.

When the event detection unit 46 detects occurrence of an event based on an output value of the acceleration sensor 20, the recording control unit 36 stores, as the event data, video data that includes a time point at which the event is detected. The recording control unit 36 stores the event data, as data for which overwrite is inhibited, in the recording unit 14. For example, the recording control unit 36 copies, from the buffer memory 32, video data of a predetermined period of about 10 seconds before and after the time point at which the event detection unit 46 detects the event, and stores the video data as the event data.

The replay control unit 38 performs control of replaying the loop recording video data or the event data that is recorded in the recording unit 14 based on a replay operation control signal that is output from the operation control unit 48, and causing the display control unit 40 to cause the display unit 16 to output the replayed video or the like.

The display control unit 40 controls display of the video data on the display unit 16. The display control unit 40 outputs a video signal for causing the display unit 16 to output the video data. More specifically, the display control unit 40 outputs a video signal that is displayed by replaying the video that is being captured by the camera 10 or one of the loop recording video data and the event data that are recorded in the recording unit 14.

The detection unit 42 detects a condition under which a voice command is not appropriately recognized in an environment in which the voice command is spoken. In the present embodiment, the detection unit 42 detects information on a language that is used by a person who speaks a voice command. The detection unit 42 detects information on a certain language that is normally used by the person who speaks the voice command, that is, a language, such as a mother tongue, that is used on a daily basis, as the language that is used by the person who speaks the voice command. The person who speaks the voice command is a passenger of the vehicle or a driver of the vehicle when the recording apparatus 1 is used in the vehicle.

The detection unit 42 acquires, for example, voice of utterance or conversations of the passenger of the vehicle from the voice that is collected by the microphone 18 while the vehicle is operating, and identifies a language that is used by the passenger of the vehicle. The detection unit 42 refers to a learning model that is subjected to machine learning with respect to a feature data or the like for each of languages, and identifies the language that is used by the passenger of the vehicle. The detection unit 42 identifies a word or a plurality of languages used by the passenger of the vehicle based on the voice of utterance or conversations of the passenger of the vehicle. The detection unit 42 may identify the language that is used, by operation that is performed by the passenger of the vehicle on the operation unit 22.

In the present embodiment, the detection unit 42 determines whether or not the language that is used by the passenger of the vehicle coincides with a language that is registered as a voice command, and determines whether or not the language is usable as the voice command. The language that is registered as a voice command is a language by which a word or a phrase that represents the voice command is registered in the recording apparatus 1. For example, a case in which a Japanese voice command is registered in the recording apparatus 1 indicates a case in which a voice command, such as “Ro-Ku-Ga-Ka-I-Shi” in Japanese, is registered. A language other than the language that is registered as a voice command, that is, a language that is not registered as a voice command, is a language by which a voice command is not registered in the recording apparatus 1.

When a plurality of languages that are used by the passenger of the vehicle are detected, and if the plurality of detected languages include a language that is registered as a voice command and a language that is not registered as a voice command, the detection unit 42 determines that the language that is used by the passenger of the vehicle is a language that is not registered as a voice command. The reason for this is that a passenger who uses the language that is not registered as a voice command may speak a voice command.

The voice command acceptance unit 44 accepts a voice command by recognizing voice that is collected by the microphone 18. For example, the voice command acceptance unit 44 performs a sound source separation process and a voice recognition process on the voice that is collected by the microphone 18, and recognizes a voice command for starting event recording. When Japanese is registered as a voice command, the voice command for starting event recording is, for example, “Ro-Ku-Ga-Ka-I-Shi”. When recognizing consecutive six syllables of “Ro-Ku-Ga-Ka-I-Shi” in the voice that is collected by the microphone 18, the voice command acceptance unit 44 outputs a control signal for starting an event recording process to the recording control unit 36. Alternatively, when recognizing voice indicating a word of “RoKuGaKaIShi” in the voice that is collected by the microphone 18, the voice command acceptance unit 44 outputs a control signal for starting the event recording process to the recording control unit 36. The voice command acceptance unit 44 determines whether or not a language that is used by a person who speaks a voice command is the language that is registered as a voice command, and changes a recognition rate for voice for determining whether or not a voice command is acquired, based on whether or not the language that is used by the person who speaks the voice command is the language that is registered as the voice command.

When the language that is used by the passenger of the vehicle is the language that is registered as the voice command, and if all of syllables among the consecutive six syllables of “Ro-Ku-Ga-Ka-I-Shi” coincide with the syllables, the voice command acceptance unit 44 determines that the voice command is acquired. The voice command acceptance unit 44 sets a first threshold for the recognition rate for determining that the voice command is acquired to, for example, 90%. In this case, when 90% or more of the six syllables of “Ro-Ku-Ga-Ka-I-Shi” is recognized, the voice command acceptance unit 44 determines that the voice command is acquired.

When the language that is used by the passenger of the vehicle is not the language that is registered as the voice command, and if five or more syllables among the consecutive six syllables of “Ro-Ku-Ga-Ka-I-Shi” coincide with the syllables, the voice command acceptance unit 44 determines that the voice command is acquired. In this case, the voice command acceptance unit 44 sets the recognition rate for determining that the voice command is acquired to a second threshold that is smaller than the first threshold. For example, the voice command acceptance unit 44 sets the second threshold to 80%. In this case, when 80% or more of the consecutive six syllables of “Ro-Ku-Ga-Ka-I-Shi” is recognized, the voice command acceptance unit 44 determines that the voice command is acquired. In other words, as in a case in which the language that is used by the passenger of the vehicle is not the language that is registered as the voice command, in a situation in which a person who speaks a voice command is not used to speaking the voice command with correct pronunciation or correct intonation or is not able to immediately speak voice, it is determined that the voice command is spoken even if the voice spoken by the passenger is not completely recognized, so that it is possible to appropriately recognize the voice command.

Furthermore, when the language that is used by the passenger of the vehicle is the language that is registered as the voice command, the voice command acceptance unit 44 sets a concordance rate between an acoustic model of an audio waveform indicating a word of “RoKuGaKaIShi” and a waveform of input voice to, for example, 90% as the first threshold for the recognition rate for determining that the voice command is acquired. In this case, when the concordance rate between the acoustic model of the audio waveform indicating the word of “RoKuGaKaIShi” and the waveform of the input voice is equal to or larger than 90%, the voice command acceptance unit 44 determines that the voice command is acquired.

Moreover, when the language that is used by the passenger of the vehicle is not the language that is registered as the voice command, the voice command acceptance unit 44 sets the concordance rate between the acoustic model of the audio waveform indicating the word of “RoKuGaKaIShi” and the waveform of the input voice to, for example, 80% as the second threshold that is smaller than the first threshold for the recognition rate for determining that the voice command is acquired. In this case, when the concordance rate between the acoustic model of the audio waveform indicating the word of “RoKuGaKaIShi” and the waveform of the input voice is equal to or larger than 80%, the voice command acceptance unit 44 determines that the voice command is acquired. In other words, when the language that is used by the passenger of the vehicle is not the language that is registered as the voice command, it is possible to allow the voice of the passenger to be more easily recognized as the voice command.

The event detection unit 46 detects an event based on acceleration that is applied to the vehicle. The event detection unit 46 detects an event based on a detection result that is obtained by the acceleration sensor 20. The event detection unit 46 detects occurrence of an event when acceleration information is equal to or larger than a threshold that is set in advance and that corresponds to a collision of the vehicle.

The operation control unit 48 acquires operation information on operation that is received by the operation unit 22. For example, the operation control unit 48 acquires storage operation information that indicates operation of manually storing video data, replay operation information that indicates replay operation, or delete operation information that indicates operation of deleting video data, and outputs a control signal. For example, the operation control unit 48 acquires termination operation information that indicates operation of terminating loop recording, and outputs a control signal. The operation control unit 48 may acquire operation information for setting the language that is used by the passenger of the vehicle, which is received by the operation unit 22. When acquiring the operation information for setting the language that is used by the passenger of the vehicle, the operation control unit 48 implements the functions in place of the detection unit 42.

The operation control unit 48 receives event recording operation by the voice command that is recognized and accepted by the voice command acceptance unit 44.

The location information acquisition unit 50 acquires location information that indicates a current location of the vehicle. The location information acquisition unit 50 calculates the location information on the current location of the vehicle by a well-known method based on the GNSS signal that is received by the GNSS reception unit 24.

### Process Performed by Control Unit

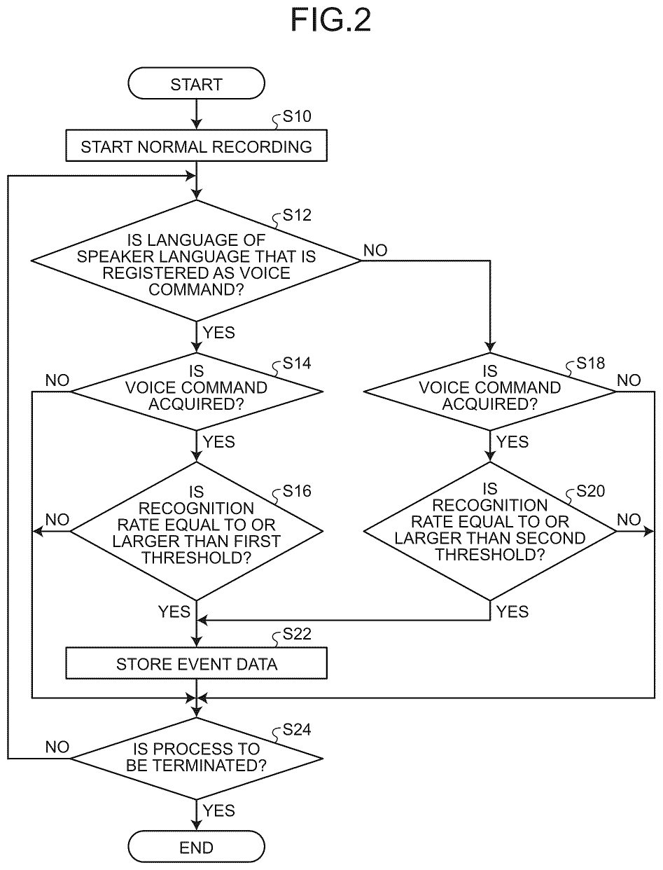

The flow of a process performed by the control unit according to the first embodiment will be described below with reference to FIG. 2. FIG. 2 is a flowchart illustrating the flow of a process performed by the control unit 26 according to the first embodiment. The flowchart illustrated in FIG. 2 is started when power, such as an engine, of the vehicle in which the recording apparatus 1 is mounted is started, or when power is supplied to the recording apparatus 1.

With the start of the process, the control unit 26 starts normal recording, that is, what is called loop recording (Step S10). Specifically, the recording control unit 36 starts a process of transmitting video data that is captured by the camera 10 to the buffer memory 32, generating a video file for each piece of video of each predetermined period, such as 60 seconds, and recording the video file in the recording unit 14, and the process goes to Step S12.

With the start of Step S10, the detection unit 42 may start to identify the language that is used by the passenger of the vehicle. The detection unit 42 may identify the language that is used by the passenger of the vehicle by acquiring utterance in the vehicle with the start of the flowchart illustrated in FIG. 2. Alternatively, with the start of the flowchart illustrated in FIG. 2, it may be possible to provide, to the passenger of the vehicle, display on the display unit 16 or a guide for inquiring a used language by voice. Alternatively, it may be possible to set a language that is identified in the past, based on an in-vehicle camera (not illustrated) or information on the passenger or the driver of the vehicle, which is associated with a smart key. Furthermore, if a vehicle in which the recording apparatus 1 is mounted is a rental car or the like, a lender of the vehicle may perform setting in advance based on the nationality or a result of conversations of a user. For example, when only a Japanese voice command is registered in the recording apparatus 1, it is detected that utterance and conversations in the vehicle are performed in a language other than Japanese. The passenger as described above may have difficulty in speaking a Japanese voice command with correct pronunciation or may have difficulty in immediately speaking a Japanese voice command with correct pronunciation.

The voice command acceptance unit 44 determines whether or not the language that is used by the passenger of the vehicle, who is the person who speaks the voice command, is the language that is registered as the voice command (Step S12). The person who speaks the voice command may be limited to the driver of the vehicle or may be a passenger other than the driver of the vehicle. When it is determined that the language that is used by the person who speaks the voice command is the language that is registered as the voice command (Step S12; Yes), the process goes to Step S14. When it is determined the language that is used by the person who speaks the voice command is not the language that is registered as the voice command (Step S12; No), the process goes to Step S18.

When it is determined as Yes at Step S12, the voice command acceptance unit 44 determines whether or not a voice command is acquired from the passenger of the vehicle by the microphone 18 (Step S14). When it is determined that the voice command is acquired (Step S14; Yes), the process goes to Step S16. When it is not determined that the voice command is acquired (Step S14; No), the process goes to Step S24.

When it is determined as Yes at Step S14, the voice command acceptance unit 44 determines whether or not the recognition rate of the acquired voice command is equal to or larger than the first threshold (Step S16). When it is determined that the recognition rate of the voice command is equal to or larger than the first threshold (Step S16; Yes), the process goes to Step S22. When it is not determined that the recognition rate of the voice command is equal to or larger than the first threshold (Step S16; No), the process goes to Step S24.

When it is determined as No at Step S12, the voice command acceptance unit 44 determines whether or not a voice command is acquired form the passenger of the vehicle by the microphone 18 (Step S18). When it is determined that the voice command is acquired (Step S18; Yes), the process goes to Step S20. When it is not determined that the voice command is acquired (Step S18; No), the process goes to Step S24.

When it is determined as Yes at Step S18, the voice command acceptance unit 44 determines whether or not the recognition rate of the acquired voice command is equal to or larger than the second threshold (Step S20). When it is determined that the recognition rate of the voice command is equal to or larger than the second threshold (Step S20; Yes), the process goes to Step S22. When it is not determined that the recognition rate of the voice command is equal to or larger than the second threshold (Step S20; No), the process goes to Step S24.

At Step S14 and Step S18, it may be possible to determine whether the acquired voice command is a highly emergent or instantaneous voice command, in addition to determining whether or not the voice command is acquired. In other words, at Step S14 and Step S18, it is determined whether or not a highly emergent or instantaneous voice command is acquired. The highly emergent or instantaneous voice command is a voice command that requests operation on a function that needs to start operation without delay upon acceptance of the voice command. For example, the highly emergent or instantaneous voice command in the recording apparatus 1 is a voice command that instructs event recording.

When it is determined as Yes at Step S16 or Yes at Step S20, the recording control unit 36 stores the event data in the recording unit 14 (Step S22). Specifically, the recording control unit 36 stores, as the event data, first video data before and after a time point at which the voice command acceptance unit 44 acquired the voice command in the recording unit 14, and the process goes to Step S24.

When it is determined as No from Step S14 to Step S20 or after Step S22, the control unit 26 determines whether or not the process is to be terminated (Step S24). Specifically, when the operation unit 22 receives operation of turning off the power supply or operation indicating termination of the process, or when the power, such as the engine, of the vehicle in which the recording apparatus 1 is mounted is turned off, the control unit 26 determines that the process is terminated. When it is determined that the process is to be terminated (Step S24; Yes), the process in FIG. 2 is terminated. When it is not determined that the process is to be terminated (Step S24; No), the process goes to Step S12.

As described above, in the first embodiment, the recognition rate for recognizing voice as a voice command is changed between when the language that is used by the passenger of the vehicle is the language that is registered as the voice command and when the language that is used by the passenger of the vehicle is not the language that is registered as the voice command, and the voice command is accepted. The voice command that is accepted by the recording apparatus 1 is, for example, a voice command for instructing event recording. Furthermore, the recording apparatus 1 accepts the voice command for instructing the event recording, and stores event data. In the first embodiment, when the language that is used by the passenger of the vehicle, that is, the person who speaks the voice command, is not the language that is registered as the voice command, a voice command is accepted and an event data storage process is performed while reducing the recognition rate as compared to the case where the language that is used by the passenger of the vehicle is the language that is registered as the voice command. With this configuration, in the first embodiment, even when the passenger is not in a state in which the passenger can appropriately speak a voice command, it is possible to appropriately store event data by giving an instruction on operation by a voice command, such as an instruction on event recording by a voice command.

### Second Embodiment

A second embodiment will be described. A voice command acceptance apparatus according to the second embodiment is a general-purpose apparatus that performs operation by using a voice command, and is applicable to, for example, a household appliance, such as a smart speaker or a television receiver, an information device, such as a smartphone, a tablet terminal, or a personal computer (PC), or a navigation device or an infotainment system used in a vehicle.

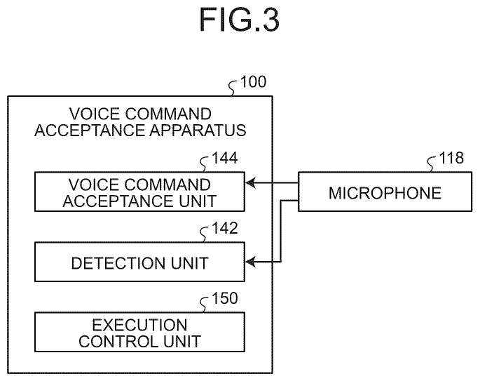

A configuration example of the voice command acceptance apparatus according to the second embodiment will be described below with reference to FIG. 3. FIG. 3 is a block diagram illustrating a configuration example of a voice command acceptance apparatus 100 according to the second embodiment.

As illustrated in FIG. 3, the voice command acceptance apparatus 100 includes a voice command acceptance unit 144, a detection unit 142, and an execution control unit 150. The voice command acceptance apparatus 100 includes, for example, an information processing device, such as a CPU or an MPU, and a storage device, such as a RAM or a ROM. The voice command acceptance apparatus 100 executes a program according to the present disclosure. The voice command acceptance apparatus 100 may be implemented by, for example, an integrated circuit, such as an ASIC or an FPGA. The voice command acceptance apparatus 100 may be implemented by a combination of hardware and software. The voice command acceptance apparatus 100 is a control unit that controls an apparatus that uses a voice command, similarly to the control unit 26 of the first embodiment. Therefore, the voice command acceptance apparatus 100 may include a component that operates or implements a function based on the accepted voice command.

The voice command acceptance apparatus 100 acquires voice from a microphone 118. The microphone 118 may be included in the voice command acceptance apparatus 100.

The microphone 118 collects voice that is spoken by a speaker. The microphone 118 outputs voice related to the collected voice to the voice command acceptance apparatus 100. The microphone 118 may be configured in an integrated manner with the voice command acceptance apparatus 100 or may be configured as a separate body.

The voice command acceptance unit 144 accepts a voice command. For example, the voice command acceptance unit 144 accepts a voice command by recognizing the voice that is collected by the microphone 118. The voice command acceptance unit 144 has the same functions as those of the voice command acceptance unit 44 of the first embodiment.

The detection unit 142 detects a condition under which a voice command is not appropriately recognized in an environment in which the voice command is spoken. In the present embodiment, the detection unit 142 acquires information on a language that is used by a person who speaks the voice command. The detection unit 142 acquires information on a certain language that is normally used by the person who speaks the voice command, that is, a language, such as a mother tongue, that is used on a daily basis, as the language that is used by the person who speaks the voice command. The detection unit 142 has the same functions as those of the detection unit 42 of the first embodiment.

When the voice command acceptance unit 144 accepts a voice command, the execution control unit 150 implements a function with respect to the accepted voice command.

The voice command acceptance unit 144 accepts a voice command while changing the recognition rate of the voice command in accordance with whether or not the language that is used by the person who speaks the voice command is a language that is made available by being registered as a voice command, based on a detection result that is obtained by the detection unit 142. For example, when it is determined that the language that is used by the person who speaks the voice command is the language that is registered as the voice command, the voice command acceptance unit 144 accepts a voice command at the recognition rate that is equal to or larger than the first threshold. For example, when it is determined that the language that is used by the person who speaks the voice command is not the language that is registered as the voice command, the voice command acceptance unit 144 accepts a voice command at the recognition rate that is equal to or larger than the second threshold that is smaller than the first threshold.

As for a highly emergent or instantaneous voice command, the voice command acceptance unit 144 may accept the voice command at a recognition rate that is equal to or larger than the second threshold. In the second embodiment, a highly emergent or instantaneous voice command is a voice command for a certain function, such as an emergency call, emergency communication, an instruction to start recording of a broadcast content, or an instruction to stop a function with a high continuing risk, for which a delay from an operation time point is not preferable or for which an inverse effect or a risk may occur due to a delay with respect to start or stop of execution of the function.

### Process Performed by Voice Command Acceptance Apparatus

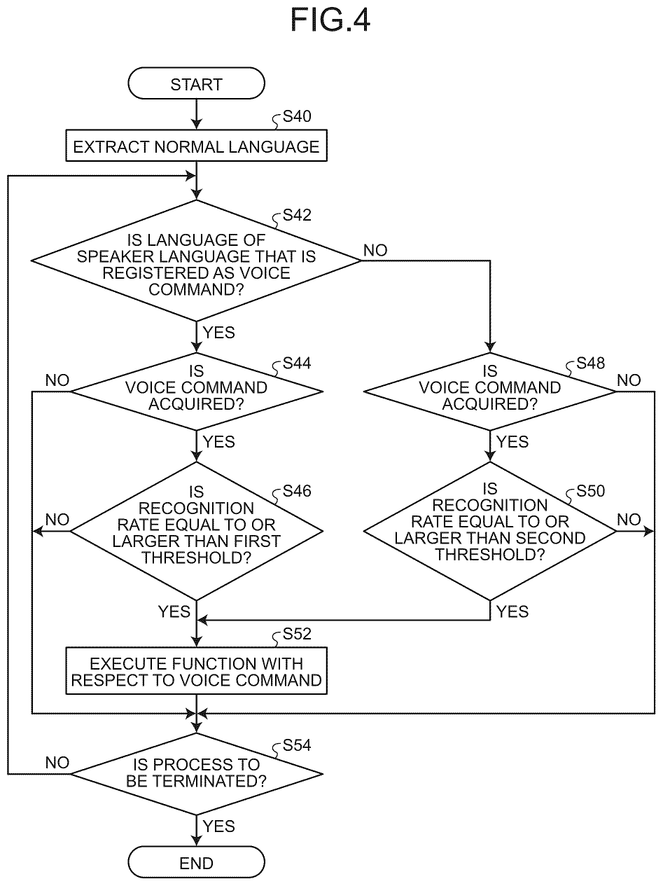

The flow of a process performed by the voice command acceptance apparatus according to the second embodiment will be described below with reference to FIG. 4. F FIG. 4 is a flowchart illustrating the flow of a process performed by the voice command acceptance apparatus 100 according to the second embodiment.

The detection unit 142 extracts a language that is used by a person who speaks a voice command (Step S40), and the process goes to Step S42. Specifically, the detection unit 142 extracts the language that is used by the person who speaks the voice command based on a content of utterance that is spoken in the vicinity of the voice command acceptance apparatus 100.

The voice command acceptance unit 144 determines whether or not the language that is used by the person who speaks the voice command is the language that is registered as the voice command (Step S42). Specifically, the voice command acceptance unit 144 determines whether or not the language is the language that is registered as the voice command of the voice command acceptance apparatus 100 based on a result that the detection unit 142 has obtained by detecting the language that is used by the person who speaks the voice command. When it is determined that the language that is used by the person who speaks the voice command is the language that is registered as the voice command (Step S42; Yes), the process goes to Step S44. When it is determined that the language that is used by the person who speaks the voice command is not the language that is registered as the voice command (Step S42; No), the process goes to Step S48.

When it is determined as Yes at Step S42, the voice command acceptance unit 144 determines whether or not a voice command is acquired by the microphone 118 (Step S44). When it is determined that the voice command is acquired (Step S44; Yes), the process goes to Step S46. When it is not determined that the voice command is acquired (Step S44; No), the process goes to Step S54.

When it is determined as Yes at Step S44, the voice command acceptance unit 144 determines whether or not the recognition rate of the acquired voice command is equal to or larger than the first threshold (Step S46). When it is determined that the recognition rate of the voice command is equal to or larger than the first threshold (Step S46; Yes), the process goes to Step S52. When it is not determined that the recognition rate of the voice command is equal to or larger than the first threshold (Step S46; No), the process goes to Step S54.

When it is determined as No at Step S42, the voice command acceptance unit 144 determines whether or not a voice command is acquired by the microphone 118 (Step S48). When it is determined that the voice command is acquired (Step S48; Yes), the process goes to Step S50. When it is not determined that the voice command is acquired (Step S48; No), the process goes to Step S54.

When it is determined as Yes at Step S48, the voice command acceptance unit 144 determines whether or not the recognition rate of the acquired voice command is equal to or larger than the second threshold (Step S50). When it is determined that the recognition rate of the voice command is equal to or larger than the second threshold (Step S50; Yes), the process goes to Step S52. When it is not determined that the recognition rate of the voice command is equal to or larger than the second threshold (Step S50; No), the process goes to Step S54.

At Step S44 and Step S48, it may be possible to determine whether or not the acquired voice command is a highly emergent or instantaneous voice command, in addition to determining whether or not the voice command is acquired.

When it is determined as Yes at Step S46 or Yes at Step S50, the execution control unit 150 executes a function with respect to the voice command (Step S52). Then, the process goes to Step S54.

When it is determined as No from Step S44 to Step S50 or after Step S52, the voice command acceptance apparatus 100 determines whether or not the process is to be terminated (Step S54). Specifically, the voice command acceptance apparatus 100 determines that the process is to be terminated when receiving operation of turning off the power supply or operation indicating termination of the process. When it is determined that the process is to be terminated (Step S54; Yes), the process in FIG. 4 is terminated. When it is not determined that the process is to be terminated (Step S54; No), the process goes to Step S42.

As described above, in the second embodiment, a voice command is accepted while changing the recognition rate for recognizing voice as a voice command between when the language that is used by the person who speaks the voice command is the language that is registered as the voice command and when the language that is used by the person who speaks the voice command is not the language that is registered as the voice command, and a function corresponding to the voice command is executed. In the second embodiment, when the language that is used by the person who speaks the voice command is not the language that is registered as the voice command, the voice command is accepted while reducing the recognition rate as compared to the case where the language that is used by the person who speaks the voice command is the language that is registered as the voice command. With this configuration, in the second embodiment, even when the person who speaks the voice command is a person who uses a language that is not the language that is registered as the voice command and even in a situation in which the voice command is not appropriately spoken, it is possible to appropriately execute the function with respect to the voice command.

### Third Embodiment

A third embodiment will be described. In the third embodiment, a recording apparatus that is used in a vehicle will be described as an example of the voice command acceptance apparatus.

### Recording Apparatus

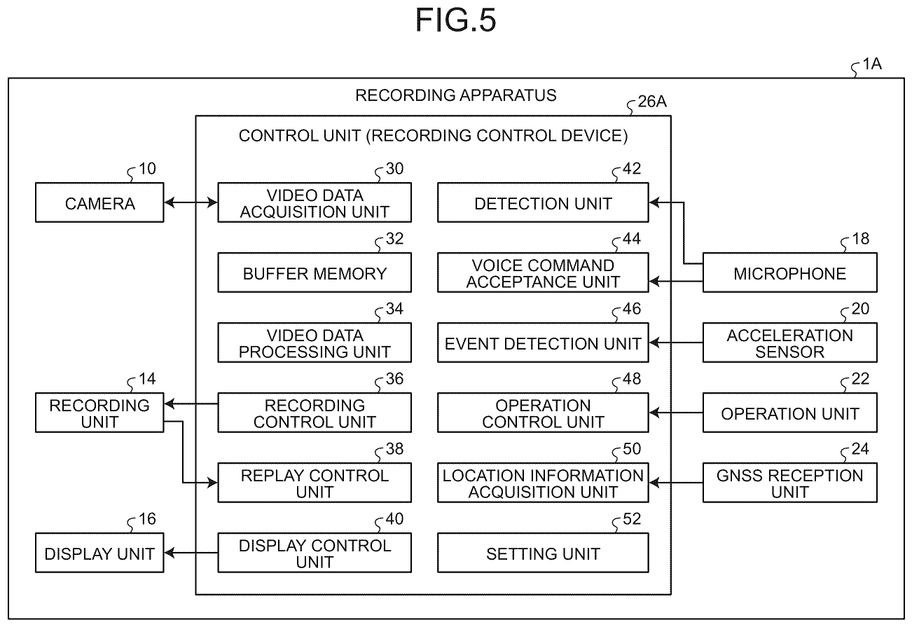

A configuration example of the recording apparatus according to the third embodiment will be described with reference to FIG. 5. FIG. 5 is a block diagram illustrating a configuration example of the recording apparatus according to the third embodiment. A recording apparatus 1A according to the third embodiment has the same configuration and the functions as those of the recording apparatus 1 according to the first embodiment; therefore, in the following explanation, the same components as those of the recording apparatus 1 will be denoted by the same reference symbols and detailed explanation thereof will be omitted. The recording apparatus 1A according to the third embodiment is an apparatus that supports a voice command in a plurality of languages, in other words, an apparatus in which a voice command is registered in the plurality of languages, and is an apparatus that selects and uses a language by which a voice command is to be accepted from among the plurality of supported languages.

As illustrated in FIG. 5, the recording apparatus 1A includes a control unit 26A in addition to the same components as those of the recording apparatus 1. The control unit 26A further includes a setting unit 52 in addition to the same components as those of the control unit 26.

The setting unit 52 sets a language by which the voice command acceptance unit 44 accepts a voice command. For example, the setting unit 52 sets at least a single language from among a plurality of languages that are supported for the voice command, by operation on the operation unit 22. In other words, the setting unit 52 selects and enables at least a single language from among voice commands for which the recording apparatus 1A support the plurality of languages.

The setting unit 52 selects and sets a language by which a voice command is accepted, from among the plurality of languages that are supported by the recording apparatus 1A, by operation that is performed on the operation unit 22 by a user of the recording apparatus 1A.

In the present embodiment, the detection unit 42 determines whether or not the language that is used by the passenger of the vehicle coincides with the language that is set as the language by which the voice command is to be accepted, and determines whether or not the language is usable as a voice command. The language that is set as the language by which the voice command is to be accepted is a language that is selected from among a plurality of languages by which words or phrases that represent voice commands are registered in the recording apparatus 1A. For example, when voice commands are registered in Japanese, English, Chinese, and Korean in the recording apparatus 1A and Japanese is selected as a language by which a voice command is to be accepted, a voice command, such as “RoKuGaKaIShi” in Japanese, is usable. Furthermore, the language other than the language that is set as the language by which the voice command is to be accepted includes a language that is not registered in the recording apparatus 1A, in addition to a language that is registered in the recording apparatus 1A but is not set as the language by which the voice command is to be accepted.

The voice command acceptance unit 44 accepts a voice command by recognizing voice that is collected by the microphone 18. When Japanese is set as the language by which a voice command is to be accepted, a voice command for starting event recording is, for example, “RoKuGaKaIShi”. The voice command acceptance unit 44 determines whether or not the language that is used by the person who speaks the voice command is the language that is set as the language by which the voice command is to be accepted, and changes the recognition rate for voice for determining whether or not a voice command is acquired, in accordance with whether or not the language that is used by the person who speaks the voice command is the language that is set as the language by which the voice command is to be accepted.

When the language that is used by the passenger of the vehicle is the language that is set as the language by which the voice command is to be accepted, and f all of syllables among the consecutive six syllables of “Ro-Ku-Ga-Ka-I-Shi” coincide with the syllables, the voice command acceptance unit 44 determines that the voice command is acquired. The voice command acceptance unit 44 sets a first threshold for the recognition rate for determining that the voice command is acquired to, for example, 90%. In this case, when 90% or more of the six syllables of “Ro-Ku-Ga-Ka-I-Shi” is recognized, the voice command acceptance unit 44 determines that the voice command is acquired.

When the language that is used by the passenger of the vehicle is not the language that is set as the language by which the voice command is to be accepted, and if five or more syllables among the consecutive six syllables of “Ro-Ku-Ga-Ka-I-Shi” coincide with the syllables, the voice command acceptance unit 44 determines that the voice command is acquired. In this case, the voice command acceptance unit 44 sets the recognition rate for determining that the voice command is acquired to a second threshold that is smaller than the first threshold. For example, the voice command acceptance unit 44 sets the second threshold to 80%. In this case, when 80% or more of the consecutive six syllables of “Ro-Ku-Ga-Ka-I-Shi” is recognized, the voice command acceptance unit 44 determines that the voice command is acquired. In other words, in a case in which the person who speaks the voice command is not used to speaking a voice command with correct pronunciation or correct intonation or is not able to immediately speak voice, such as when the language that is used by the passenger of the vehicle is not the language that is set as the language by which the voice command is to be accepted, it is possible to appropriately recognize the voice command by determining that the voice command is spoken even when the spoken voice of the passenger is not completely recognized.

Furthermore, when the language that is used by the passenger of the vehicle is the language that is set as the language by which the voice command is to be accepted, the voice command acceptance unit 44 sets a concordance rate between an acoustic model of an audio waveform indicating a word of “RoKuGaKaIShi” and a waveform of input voice to, for example, 90% as the first threshold for the recognition rate for determining that the voice command is acquired. In this case, when the concordance rate between the acoustic model of the audio waveform indicating the word of “RoKuGaKaIShi” and the waveform of the input voice is equal to or larger than 90%, the voice command acceptance unit 44 determines that the voice command is acquired.

Moreover, when the language that is used by the passenger of the vehicle is not the language that is set as the language by which the voice command is to be accepted, the voice command acceptance unit 44 sets the concordance rate between the acoustic model of the audio waveform indicating the word of “RoKuGaKaIShi” and the waveform of the input voice to, for example, 80% as the second threshold that is smaller than the first threshold for the recognition rate for determining that the voice command is acquired. In this case, when the concordance rate between the acoustic model of the audio waveform indicating the word of “RoKuGaKaIShi” and the waveform of the input voice is equal to or larger than 80%, the voice command acceptance unit 44 determines that the voice command is acquired. In other words, when the language that is used by the passenger of the vehicle is not the language that is set as the language by which a voice command is to be accepted, it is possible to allow the voice of the passenger to be more easily recognized as the voice command.

### Process Performed by Control Unit

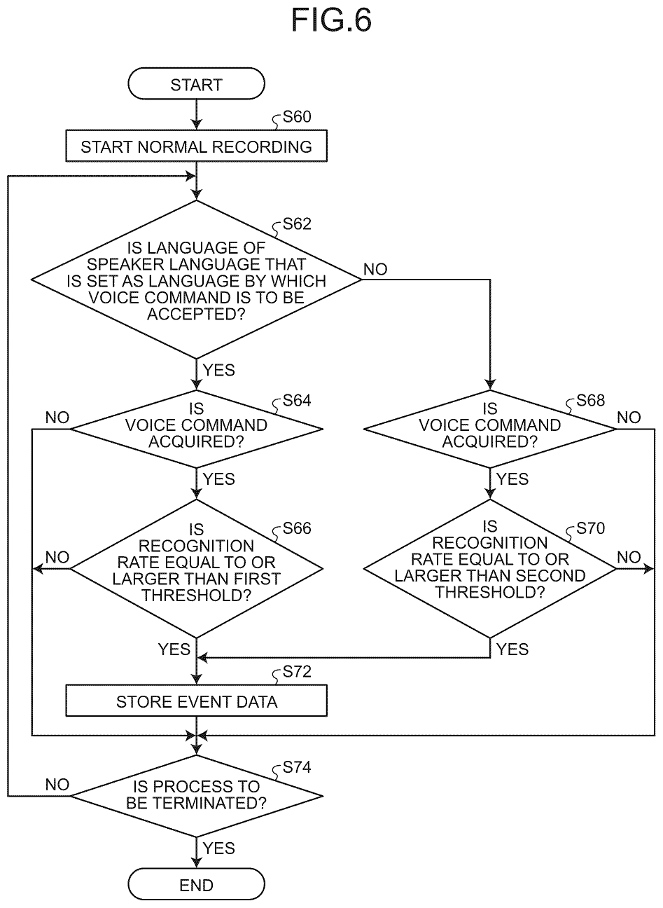

The flow of a process performed by the control unit according to the third embodiment will be described below with reference to FIG. 6. FIG. 6 is a flowchart illustrating the flow of a process performed by the control unit 26A according to the third embodiment. Processes at Step S60 and from Step S64 to Step S74 illustrated in FIG. 6 are the same as the processes at Step S10 and from Step S14 to Step S24 illustrated in FIG. 2, and therefore, explanation thereof will be omitted.

The voice command acceptance unit 44 determines whether or not the language that is used by the passenger of the vehicle, who is the person who speaks the voice command, is the language that is set as the language by which the voice command is to be accepted (Step S62). In other words, the voice command acceptance unit 44 determines whether or not the language that is used by the passenger of the vehicle, who is the person who speaks the voice command, is the language that is set by the setting unit 52. When it is determined that the language that is used by the person who speaks the voice command is the language that is set as the language by which the voice command is to be accepted (Step S62; Yes), the process goes to Step S64. When it is determined that the language that is used by the person who speaks the voice command is not the language that is set as the language by which the voice command is to be accepted (Step S62; No), the process goes to Step S68.

As described above, in the third embodiment, the recognition rate for recognizing voice as a voice command is changed between when the language that is used by the passenger of the vehicle is the language that is set as the language by which the voice command is to be accepted and when the language that is used by the passenger of the vehicle is not the language that is set as the language by which the voice command is to be accepted, and the voice command is accepted. In the third embodiment, when the language that is used by the person who speaks the voice command, that is, the passenger of the vehicle, is not the language that is set as the language by which the voice command is to be accepted, the voice command is accepted while changing the recognition rate as compared to the case in which the language that is used by the person who speaks the voice command is the language that is set as the language by which the voice command is to be accepted. With this configuration, in the third embodiment, even when the passenger is not in a state in which the passenger can appropriately speak a voice command, it is possible to appropriately give an instruction on operation, such as storage of event data, by the voice command.

### Fourth Embodiment

A fourth embodiment will be described. A voice command acceptance apparatus according to the fourth embodiment is applicable to various kinds of apparatuses that perform operation by using a voice command, similarly to the voice command acceptance apparatus according to the second embodiment.

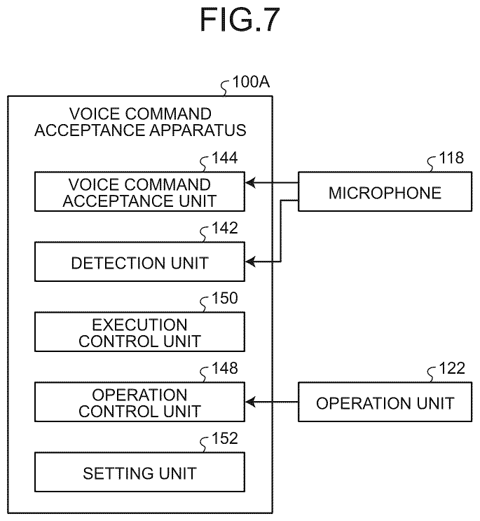

A configuration example of the voice command acceptance apparatus according to the fourth embodiment will be described below with reference to FIG. 7. FIG. 7 is a block diagram illustrating a configuration example of a voice command acceptance apparatus 100A according to the fourth embodiment. The voice command acceptance apparatus 100A according to the fourth embodiment has the same configurations as those of the voice command acceptance apparatus 100 according to the second embodiment; therefore, in the following explanation, the same components as those of the voice command acceptance apparatus 100 and detailed explanation thereof will be omitted.

A illustrated in FIG. 7, the voice command acceptance apparatus 100A further includes an operation unit 122, an operation control unit 148, and a setting unit 152, in addition to the same components as those of the voice command acceptance apparatus 100. The operation unit 122 may be configured as a constituent element of the voice command acceptance apparatus 100A.

The operation unit 122 is able to receive various kinds of operation on the voice command acceptance apparatus 100A. The operation unit 122 is able to receive operation for setting a language by which a voice command is to be accepted from among a plurality of languages that are supported by the voice command acceptance apparatus 100A. The operation unit 122 outputs operation information to the operation control unit 148.

The operation control unit 148 acquires the operation information on the operation that is received by the operation unit 122. For example, the operation control unit 148 acquires operation information for setting the language by which a voice command is to be accepted.

The setting unit 152 sets the language by which a voice command is to be accepted by the voice command acceptance unit 144. The setting unit 152 has the same functions as those of the setting unit 52 according to the third embodiment.

### Process Performed by Voice Command Acceptance Apparatus

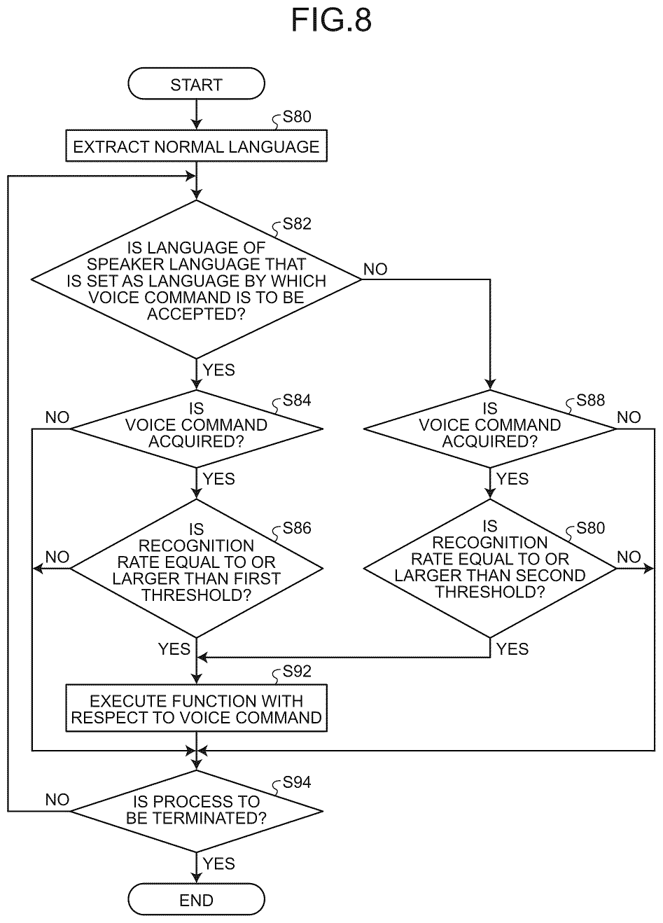

The flow of a process performed by the voice command acceptance apparatus according to the fourth embodiment will be described below with reference to FIG. 8. FIG. 8 is a flowchart illustrating the flow of a process performed by the voice command acceptance apparatus 100A according to the fourth embodiment. Processes at Step S80 and from Step S84 to Step S94 illustrated in FIG. 8 are the same as the processes at Step S40 and from Step S44 to Step S54 illustrated in FIG. 4, and therefore, explanation thereof will be omitted.

At Step S82, the voice command acceptance unit 144 determines whether or not the languages is the language that is set as the language by which the voice command is to be accepted. Specifically, the voice command acceptance unit 144 determines whether or not the language is the language that is set as the language by which the voice command is to be accepted by the voice command acceptance apparatus 100A, based on a result of the language that is used by the person who speaks the voice command, which is detected by the detection unit 142. When it is determined that the language that is used by the person who speaks the voice command is the language that is set as the language by which the voice command is to be accepted (Step S82; Yes), the process goes to Step S84. When it is determined that the language that is used by the person who speaks the voice command is not the language that is set as the language by which the voice command is to be accepted (Step S82; No), the process goes to Step S88.

As described above, in the fourth embodiment, the recognition rate for recognizing voice as a voice command is changed between when the language that is used by the person who speaks the voice command is the language that is set as the language by which the voice command is to be accepted and when the language that is used by the person who speaks the voice command is not the language that is set as the language by which the voice command is to be accepted, and the voice command is accepted and a function with respect to the voice command is implemented. In the fourth embodiment, when the language that is used by the person who speaks the voice command is not the language that is set as the language by which the voice command is to be accepted, the voice command is accepted while reducing the recognition rate as compared to the case in which the language that is used by the person who speaks the voice command is not set as the language by which a voice command is to be accepted, and the function with respect to the voice command is implemented. With this configuration, in the fourth embodiment, even when a person who speaks a voice command is a person who uses a language other than the language that is set as the language by which the voice command is to be accepted and is not in a state in which the person can appropriately speak the voice command, it is possible to appropriately implement the function with respect to the voice command.

According to the present disclosure, it is possible to appropriately perform operation by a voice command.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A voice command acceptance apparatus comprising:
a voice command acceptance unit that accepts a voice command;
a detection unit that acquires information on a language that is used by a person who speaks a voice command; and
an execution control unit that, when the voice command acceptance unit accepts a voice command, executes a function with respect to the accepted voice command, wherein
when it is determined that the language that is used by the person is a language that is usable as the voice command, the voice command acceptance unit accepts a voice command if a recognition rate of the voice command that is acquired by the voice command acceptance unit is equal to or larger than a first threshold, and
when it is determined that the language that is used by the person is not the language that is usable as the voice command, the voice command acceptance unit accepts a voice command if the recognition rate of the voice command that is acquired by the voice command acceptance unit is equal to or larger than a second threshold that is smaller than the first threshold.

2. The voice command acceptance apparatus according to claim 1, wherein
when it is determined that the language that is used by the person is a language that is usable by being registered as the voice command, the voice command acceptance unit accepts a voice command if the recognition rate of the voice command that is acquired by the voice command acceptance unit is equal to or larger than a first threshold, and
when it is determined that the language that is used by the person is not the language that is usable by being registered as the voice command, the voice command acceptance unit accepts a voice command if the recognition rate of the voice command that is acquired by the voice command acceptance unit is equal to or larger than a second threshold that is smaller than the first threshold.

3. The voice command acceptance apparatus according to claim 1, further comprising:
a setting unit that sets a language by which a voice command is to be accepted by the voice command acceptance unit, wherein
when it is determined that the language that is used by the person is a language that is usable by being set, by the setting unit, as the language by which a voice command is to be accepted, the voice command acceptance unit accepts a voice command if the recognition rate of the voice command that is acquired by the voice command acceptance unit is equal to or larger than a first threshold, and
when it is determined that the language that is used by the person is not the language that is usable by being set, by the setting unit, as the language by which a voice command is to be accepted, the voice command acceptance unit accepts a voice command if the recognition rate of the voice command that is acquired by the voice command acceptance unit is equal to or larger than a second threshold that is smaller than the first threshold.

4. The voice command acceptance apparatus according to any one of claim 1, wherein the detection unit acquires information on the language that is used by the person based on utterance of the person.

5. The voice command acceptance apparatus according to any one of claim 1, wherein the voice command acceptance unit the voice command acceptance unit accepts, with respect to one of a highly emergent voice command and a highly instantaneous voice command, the voice command if the recognition rate of the voice command that is acquired by the voice command acceptance unit is equal to or larger than a second threshold that is smaller than the first threshold.

6. The voice command acceptance apparatus according to any one of claim 1,
the voice command acceptance apparatus is a vehicle recording control device that is used in a vehicle,
the voice command acceptance apparatus further comprising:
a video data acquisition unit that acquires first video data that is captured by a first image capturing unit that captures an image of surroundings of the vehicle, wherein
the voice command acceptance unit receives an instruction on event recording by a voice command, and
the execution control unit, when the voice command acceptance unit receives the instruction on the event recording by the voice command, stores, as event data, the first video data that includes a time point at which the instruction on the event recording is received.

7. A voice command acceptance method implemented by a voice command acceptance apparatus, the voice command acceptance method comprising:
acquiring information on a language that is used by a person who speaks a voice command;
accepting, when it is determined that the language that is used by the person is a language that is usable as the voice command, a voice command if a recognition rate of the voice command is equal to or larger than a first threshold,
accepting, when it is determined that the language that is used by the person is not the language that is usable as the voice command, a voice command if the recognition rate of the voice command is equal to or larger than a second threshold that is smaller than the first threshold; and
executing, when the voice command is accepted, a function with respect to the accepted voice command.
